(19) United States
(12) Patent Application Publication
(10) Pub. No.: US 2022/0073788 A1
(43) Pub. Date: Mar. 10, 2022

(54) Adhesive-Backed Composite Film

(71) Applicant: 3M INNOVATIVE PROPERTIES COMPANY, St. Paul, MN (US)

(72) Inventors: Justin M. BOLTON, Minneapolis, MN (US); Ryan E. MARX, Rosemount, MN (US); Marco CAPROTTI, Treviolo (IT); Alvaro S. DOMENIGHI, St. Paul, MN (US); Robert M. VORWERK, Woodbury, MN (US); Daniel C. MUNSON, Maplewood, MN (US); Patrizia CAPOGRECO, Monza (IT)

(21) Appl. No.: 17/422,970

(22) PCT Filed: Jan. 20, 2020
(86) PCT No.: PCT/IB2020/050425

§ 371 Date: Jul. 14, 2021

Related U.S. Application Data
(60) Provisional application No. 62/800,268, filed on Feb. 1, 2019.

(51) Int. Cl. C09J 7/25; C09J 7/38; C08K 5/13; C08K 5/00; B60C 1/00

(52) U.S. Cl. CPC C09J 7/25; C09J 7/387; C08K 5/13; C08K 5/0041; B60C 1/00; C09J 2203/334; C09J 2301/414; C09J 2453/00; C09J 2475/001; C09J 2475/008; C09J 2425/00; C09J 2203/354; C09J 2301/302; C09J 2301/408

(57) ABSTRACT

Provided is a composite film for attachment to an elastomeric substrate. The composite film comprises the following layers, in the order below: an elastomeric layer comprising a thermoplastic polyurethane; an ink layer; and a pressure sensitive adhesive layer comprising a styrenic block copolymer blended with a phenolic resin. Advantageously, the provided composite films can withstand harsh outdoor environments and stresses while providing high anchorage to elastomeric substrates, such as car tires, for a long service life.

### FIELD OF THE INVENTION

Provided are adhesive-backed composite films. The adhesive-backed composite films are suitable for bonding to elastomeric substrates such as pneumatic tires.

### BACKGROUND

Bonding to elastomeric substrates can be a significant technical challenge, particularly in applications requiring durability in the face of extreme outdoor environments. Tire manufacturers, for example, have sought a permanent and durable label solution that can withstand harsh road or environmental conditions during operational use and for long periods of time while maintaining a good visual appearance. A durable and easy-to-apply label would allow tire manufacturers to add visible branding to their products, thus bringing differentiation to their products and enabling them to capture more value in this market.

One challenge has been to provide an economical, long-lasting label that fits readily within existing manufacturing processes for high volume production and maintains a good visual appearance over the life of the tire. Competitive solutions in the aftermarket consist of marking pens used to color the side of a tire for temporary labeling or thick, butyl rubber-based labels that are manually applied and adhered using cyanoacrylates. Neither of these approaches provide an adequate solution with respect to achieving high rate production and long-lasting performance.

### SUMMARY

The composite films described herein address the challenges that have persisted in this application. These films use a polyurethane film designed to withstand harsh environmental conditions and a pressure sensitive adhesive capable of adhering to certain elastomeric substrates, enabling these films to withstand the stresses and environmental conditions encountered during operation and become integrated into a high rate tire production process. The polyurethane film is scratch and abrasion resistant, thus protecting the integrity of the ink in-service. Optionally, the polyurethane can have an ultraviolet light (UV) protection package that resists yellowing and minimizes color changes of the ink layer. As a further option, the PSA can contain a colorant such as a pigment or dye, thereby serving as both an adhesive and a colored film layer. In such instances, the colored film layer could provide a background color to the ink layer.

In a first aspect, a composite film for attachment to an elastomeric substrate is provided. The composite film comprises the following layers, in the order below: an elastomeric layer comprising a thermoplastic polyurethane; an ink layer; and a pressure sensitive adhesive layer comprising a styrenic block copolymer blended with a phenolic resin.

In a second aspect, a pneumatic tire comprising the composite film is provided, wherein the elastomeric substrate is part of the pneumatic tire.

In a third aspect, a process of applying the composite film onto the elastomeric substrate is provided, the process comprising: placing the pressure sensitive adhesive layer of the composite film in contact with the elastomeric substrate; and heating the composite film to crosslink and bond the pressure sensitive adhesive layer to the elastomeric substrate.

In a fourth aspect, a process of making a composite film is provided, comprising: disposing an ink layer on an elastomeric layer, wherein the elastomeric layer comprises a thermoplastic polyurethane; and disposing a pressure sensitive adhesive layer on the ink layer, the pressure sensitive adhesive layer comprising a styrenic block copolymer blended with a phenolic resin.

Advantageously, the provided composite films can provide a durable, semi-permanent label for a tire sidewall. The label comprises a polyurethane film, an ink layer, and a rubber-based pressure sensitive adhesive that can form crosslinks when applied with heat. The crosslinks allow the adhesive to cure into a structural or semi-structural adhesive bonded to the tire, resulting in a semi-permanent label.

This article differs from conventional tire stickers because the ink is printed under a durable, abrasion resistant polyurethane film to protect the integrity of the printed features. Further, these composite films can provide a high level of anchorage (higher than standard acrylic, silicone and rubber PSA) for long service life. The combination of polyurethane film, flexible ink, and rubber-based PSA results in a label that can withstand the harsh environment and stresses typically encountered by vehicle tires.

### BRIEF DESCRIPTION OF THE DRAWINGS

FIGS. 1-3 are a side, cross-sectional views of a composite film according to various exemplary embodiments, each bonded to a respective substrate.

Repeated use of reference characters in the specification and drawings is intended to represent the same or analogous features or elements of the disclosure. Numerous other modifications and embodiments can be devised by those skilled in the art, which fall within the scope and spirit of the principles of the disclosure. The figures may not be drawn to scale.

### Definitions

As used herein:
“ambient conditions” means at a temperature of 25 degrees Celsius and a pressure of 1 atmosphere (approximately 100 kilopascals);
“ambient temperature” means at a temperature of 25 degrees Celsius;
“cure” means to alter the physical state and or chemical state of the composition to make it transform from a fluid to less fluid state, to go from a tacky to a non-tacky state, to go from a soluble to insoluble state, to decrease the amount of polymerizable material by its consumption in a chemical reaction, or go from a material with a specific molecular weight to a higher molecular weight;
“curable” means capable of being cured; and
“molecular weight” refers to weight-average molecular weight (M_{w}), measured using size exclusion chromatography as described in U.S. Pat. No. 4,780,367 (Lau, et al.).

### DETAILED DESCRIPTION

Objects and advantages of this disclosure are further illustrated by the following non-limiting examples, but the materials and amounts thereof recited in these examples, as well as other conditions and details, should not be construed to unduly limit this disclosure.

As used herein, the terms “preferred” and “preferably” refer to embodiments described herein that may afford certain benefits under certain circumstances. However, other embodiments may also be preferred, under the same or other circumstances. Furthermore, the recitation of one or more preferred embodiments does not imply that other embodiments are not useful, and other embodiments are not excluded from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein.

Relative terms such as left, right, forward, rearward, top, bottom, side, upper, lower, horizontal, vertical, and the like may be used herein and, if so, are from the perspective observed in the particular figure. These terms are used only to simplify the description, however, and not to limit the scope of the invention in any way. Figures are not necessarily to scale.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the features, structures, materials, or characteristics may be combined in any suitable manner in one or more embodiments.

Composite films according to the present disclosure have a primary use in adhesive-backed labels for pneumatic tires. Such tires can be useful in, for example, automobiles, commercial vehicles, and aircraft. These films, however, need not be so limited. Other applications can be found in labeling of rubber products in general, which are extremely diverse and include boots, raincoats, pillows, cushions, gripping surfaces, rug backings, roofing shingles, plugs and washers.

Such films may serve functional purposes, ornamental purposes, or both. In various applications, the provided films may provide visible markings to assist in branding, identification or use of a product. In some cases, a film might provide information about the grade, price, name, and/or features associated with a given product. Ornamental films can impart aesthetically pleasing colors to a product.

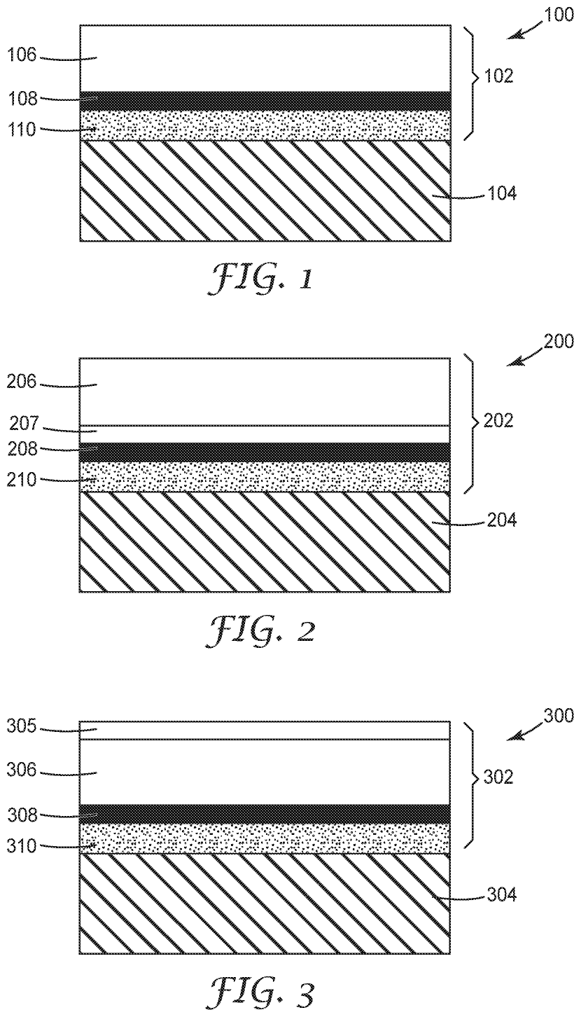

A composite film according to one embodiment is shown permanently bonded to an elastomeric substrate in FIG. 1. This figure depicts a bonded assembly hereinafter referred to by the numeral 100, which includes an adhesive-backed composite film 102 and an elastomeric substrate 104 adhered thereto. The elastomeric substrate 104 can be part of a tire for a vehicle, such as a pneumatic tire, as previously noted. Alternatively, the elastomeric substrate 104 can be part of any other article made from a rubber, or otherwise elastomeric, material. Elastomeric materials can be thermosets or thermoplastics and display viscoelastic properties. In some cases, elastomeric materials can be reversibly stretched to a length of at least 100%, at least 200%, at least 500% or at least 700%, relative to its original unstretched state.

The film 102 includes, in the following order, an elastomeric layer 106, an ink layer 108, and a pressure-sensitive adhesive layer 110. It is to be understood, however, that the film 102 is not limited to the aforementioned layers—one or more additional layers can be present, either on the exposed major surface of an outer layer or between two other layers. Each of the elastomeric layer 106, ink layer 108, and pressure-sensitive adhesive layer 110 is described in more detail below.

The elastomeric layer 106 can provide a durable and abrasion-resistant outer surface to the composite film 102. This layer is preferably transparent to present a clear view of the underlying ink layer 108. In a preferred embodiment, the elastomeric layer 106 is made from a polyurethane, such as a thermoplastic polyurethane. The thermoplastic polyurethane can be an aliphatic thermoplastic polyurethane, which can provide excellent optical characteristics, high flexibility, good heat and UV resistance, and good chip resistance. Useful elastomeric layers include those used in backings of certain adhesive-backed polyurethane tapes, including “3M Polyurethane Protective Tape 8616” manufactured by 3M Company of St. Paul, Minn.

The outward-facing surface of the elastomeric layer 106 can be smooth or textured, depending on the desired application. Exemplary textured surfaces include matte surfaces, brushed surfaces, and patterned surfaces characterized by channels, ridges, depressions, and/or protrusions having a regular spacing. Such textures can be provided for ornamental purposes or for enhanced visual prominence when affixed to the elastomeric substrate 104.

The thickness of the elastomeric layer 106 is not particularly restricted. Preferably the layer is sufficiently thin to allow the overall composite film 102 to stretch as needed to conform to a substrate having curved or possibly irregularly shaped contours, but sufficiently thick to protect the substrate against scratches and impacts encountered in use. The thickness of the elastomeric layer 106 can be from 25 micrometers to 500 micrometers, from 50 micrometers to 250 micrometers, from 75 micrometers to 150 micrometers, or in some embodiments, less than, equal to, or greater than 25 micrometers, 30, 35, 40, 45, 50, 60, 70, 80, 90, 100, 110, 120, 130, 140, 150, 175, 200, 225, 250, 300, 350, 400, 450, or 500 micrometers.

The ink layer 108 provides visual contrast against the elastomeric substrate, which in the case of tires is generally black in color. The visual contrast can be provided by a colorant, commonly a dye or pigment, dispersed in a binder polymer. Exemplary inks include the Screen Printing Ink Series 1900 available from 3M Company of St. Paul, Minn.

In some embodiments, the ink layer 108 is made from a thermoset polymer containing a soluble dye. The thermoset polymer can be cured using actinic radiation, such as UV, visible light, heat, or pressure. In one exemplary embodiment, the ink layer 108 is comprised of a polyurethane-based ink. Any of a variety of solvent-based inks can also be used, which in some instances may be curable by actinic radiation. Color can also be imparted by a pigment, a particulate colorant that is insoluble in the binder polymer. Suitable binders can be based on polyurethane and/or acrylic polymers.

Relatively small amounts of colorant can be used to suffuse the ink layer 108 with color. The amount of colorant can be from 2% to 80%, from 5% to 60%, from 20% to 50%, or in some embodiments, less than, equal to, or greater than 2%, 3, 4, 5, 6, 7, 8, 9, 10, 15, 20, 25, 30, 35, 40, 45, 50, 55, 60, 65, 70, 75, or 80% by weight, relative to the overall weight of the corresponding colored region in the ink layer 108.

The ink layer 108 can disposed on the elastomeric layer 106 (or other adjacent layer) using any known method. Such methods include ink-jet printing, flexographic printing, contact printing, thermal transfer printing, and gravure coating. The ink layer 108 can be continuous or discontinuous.

Moreover, the ink layer 108 may be either single-layered or multi-layered, where each individual layer can be continuous or discontinuous. The layers can cover the same or different areas along the composite film 102. Moreover, a given layer can cover none of, partially cover, or fully cover, another layer. A given layer may be patterned, if desired. Patterned layers may be in forms including, for example, lines, dots, squares, circles, and combinations thereof. A given layer within a multilayered ink layer 108 can have a thickness that is uniform or varies across the composite film 102.

The ink layer 108 preferably has a thickness sufficient to provide visual contrast by itself or with a background color provided by the pressure-sensitive adhesive layer 110 as shall be described further below. Typical solvent based ink coatings can be 3 to 12 micrometers in thickness. Typical UV-cured ink printings can be 6 to 12 micrometers in thickness. Typical gravure printings can be approximately 5 micrometers in thickness, and optionally disposed on a metallized layer.

In general, the thickness of the ink layer 108 can be from 0.5 micrometers to 25 micrometers, from 1 micrometer to 20 micrometers, from 3 micrometers to 12 micrometers, or in some embodiments, less than, equal to, or more than 0.5 micrometers, 0.6, 0.7, 0.8, 0.9, 1.0, 1.5, 2.0, 2.5, 3.0 3.5, 4.0, 4.5, 5.0, 5.5, 6.0, 7.0, 7.5, 8.0, 8.5, 9.0, 9.5, 10, 15, 20, or 25 micrometers.

The pressure-sensitive adhesive layer 110 adhesively couples the ink layer 108 to the elastomeric substrate 104. Useful pressure-sensitive adhesives in the layer 110 include styrenic block copolymers, including styrenic triblock and star block copolymers available under the trade designation KRATON, available from Kraton Corporation, Houston, Tex. Examples of these various block copolymer architectures are described in U.S. Pat. No. 4,780,367 (Lau et al.).

Each block within the styrenic block copolymer can have a molecular weight of from 5000 g/mol to 200,000 g/mol, from 5000 g/mol to 150,000 g/mol, from 5000 g/mol to 100,000 g/mol, or in some embodiments, less than, equal to, or greater than 1000 g/mol; 2000; 3000; 4000; 5000; 7000; 10,000; 12,000; 15,000; 17,000; 20,000; 30,000; 40,000; 50,000; 70,000; 100,000, 120,000; 150,000; 170,000; or 200,000 g/mol. Styrene repeat units can represent up to 25% by weight of the styrenic block copolymer, with the balance comprised of isoprene or butadiene repeat units. The styrenic block copolymer can have an overall molecular weight of at least 20,000 g/mol; at least 280,000 g/mol; at least 380,000 g/mol; at least 775,000 g/mol; at least 1,000,000 g/mol; or at least 1,200,000 g/mol. Increasing the molecular weight of the block copolymer can significantly improve its stability at high temperatures.

The styrenic block copolymer can be blended with a phenolic resin, which was found to significantly improve anchorage to elastomeric substrates such as tire sidewalls. The phenolic resin is preferably reactive with the styrenic block copolymer, elastomeric substrate, or both. In some embodiments, the phenolic resin functions as a crosslinker for the pressure-sensitive adhesive. Phenolic resin crosslinkers can be heat-activated, allowing for crosslinking to be triggered when the adhesive is thermally laminated to a substrate.

The phenolic resin can contain hydroxymethyl groups that are reactive with rubber materials, and particularly styrenic block copolymers. It is also possible for the hydroxymethyl groups to be further reactive with the elastomeric substrate, enabling the composite film and the elastomeric substrate to be covalently bonded to each other.

Useful phenolic resins can be derived from alkyl phenols, such as octyl phenol. One commercially available phenolic resin is HRJ-10518, available from SI Group of Schenectady, N.Y.

The phenolic resin can be present in an amount sufficient to improve anchorage to the elastomeric substrate. When used as a crosslinker, the amount can be limited to avoid inducing brittleness in the adhesive. In exemplary embodiments, the phenolic resin is from 2% to 60%, from 4% to 40%, from 6% to 30%, or in some embodiments, less than, equal to, or greater than 2%, 3, 4, 5, 6, 7, 8, 9, 10, 15, 20, 25, 30, 35, 40, 45, 50, or 60% by weight relative to the overall weight of the adhesive composition.

In cases where it is desired for the ink layer to display features with a background color, it can be advantageous for the styrenic block copolymer blend to contain a colorant. Since the features of the ink layer 108 may not be completely opaque, it can also be beneficial to provide a background color for consistent color fidelity. Use of a white background can also help accentuate any colored regions in the ink layer 108.

The thickness of the pressure-sensitive adhesive layer 110 can be from 15 micrometers to 100 micrometers, from 30 micrometers to 80 micrometers, from 40 micrometers to 60 micrometers, or in some embodiments, less than, equal to, or more than 15 micrometers, 16, 17, 18, 19, 20, 25, 30, 35, 40, 45, 50, 55, 60, 65, 70, 75, 80, 85, 90, 95, or 100 micrometers.

In some embodiments, one or more of the layers have a major surface that is surface-treated. Surface treatment can alter the surface energy of polymeric materials and improve the wetting of a subsequently applied layer. Surface treatment can also provide increased interlayer adhesion.

The surface-modified major surface can be, for instance, a corona-treated surface. Corona treatment works by creating an electrical field around the layer to be treated. This electric field ionizes the air molecules to form ionized air molecules such as ozone and nitrous oxides, thereby oxidizing the major surface of the layer. Carbon-hydrogen groups on the surface can be replaced with hydroxyl groups, carboxylic acid groups, and sometimes amine or nitrous groups. These groups in turn can provide active sites for covalent bonding between layers.

Equipment used to perform corona treatment generally includes a high-frequency power generator, a high-voltage transformer, a stationary electrode, and a treater ground roll. Electrical power is converted into higher frequency power which is then supplied to the treater station. The treater station applies this power using electrodes through an air gap and onto the major surface of the layer to be corona treated. Dosage can vary as needed to achieve the desired degree of surface functionalization.

Other ways to induce surface treatment include, but are not limited to, plasma activation, surface grafting, and chemical etching.

Advantageously, a major surface of the elastomeric layer 106 facing the ink layer 108, a major surface of the ink layer 108 facing either the elastomeric layer 106 or the pressure-sensitive adhesive layer 110, or combination thereof, can be surface treated. Corona treatment in particular was found to be effective in improving the integrity of the composite film 102 when applied to certain elastomeric substrates, such as automotive tires.

Alternatively, or in combination with surface treatment, the composite film 102 can include other layers to improve inter-layer adhesion, including primer layers, physical adhesive promoters, and tie layers.

Generally, the layers of the composite film 102 can be coated or laminated to each other according to any known method. In an exemplary process of making the composite film 102, it can be advantageous to perform surface-treatment on one surface of the elastomeric layer 106, dispose the ink layer 107 onto the surface-modified elastomeric layer 106, perform surface-treatment on the exposed surface of the ink layer 107, then dispose the pressure-sensitive adhesive layer 110 onto the surface-modified ink layer 107.

FIG. 2 shows an assembly 200 in which a composite film 202 bonded to a substrate 204 that includes an elastomeric layer 206, tie layer 207, ink layer 208, and pressure-sensitive adhesive layer 210. The tie layer 207 is a polymeric layer disposed between the elastomeric layer 206 and ink layer 208 that enhances adhesion between these layers. Useful tie layers include polyurethane layers and blends of polyurethane and alkylene copolymers. A polyurethane tie layer can be co-extruded with the elastomeric layer 106 or coated or laminated onto the elastomeric layer 106 in a subsequent operation.

The tie layer can have any appropriate thickness, such as from 2 micrometers to 50 micrometers, from 5 micrometers to 25 micrometers, from 10 micrometers to 15 micrometers, or in some embodiments, less than, equal to, or greater than 2 micrometers, 3, 4, 5, 6, 7, 8, 9, 10, 11, 12, 13, 14, 15, 16, 17, 18, 19, 20, 25, 30, 35, 40, 45, or 50 micrometers.

Adhesion promoters and primers are known to those of ordinary skill and can also be useful in improve interlayer adhesion. These could include, for example, primers available from 3M Company, St. Paul, Minn. for improving adhesion of tape, film, and vinyl graphics to plastic, rubber, and painted substrates.

FIG. 3 shows an assembly 300 in which a protective layer 305 is disposed on the elastomeric layer 306 to avoid damage to elastomeric layer 306 during storage, transport, and installation. In instances where the elastomeric layer 306 is textured, the protective layer can also serve the purpose of enabling pressure-sensitive adhesive layer 310 to be heated from the backing-side of the composite film 302 through the protective layer 305, elastomeric layer 306, and ink layer 308 without damaging or distorting the surface texture.

The protective layer 305 can be provided by release liner. Examples of suitable release liners include: paper, polymer film (for example, polyester, polyethylene, or polypropylene), or other polymeric film material. The release liner may be coated with a material to decrease the amount of adhesion between the release liner and the adhesive layer. Such coatings can include, for example, a silicone or fluorochemical material. In some embodiments, the protective layer 305 is comprised of a silicone-coated polyester film.

Where the elastomeric layer 306 is textured, the protective layer 305 itself may have a surface texture complemental to that of the elastomeric layer 306 to preserve the surface texture during storage of the composite film 302. Conveniently, a textured protective layer 305 can be used to emboss the texture onto the elastomeric layer 306 in its manufacture, as described in U.S. Pat. No. 8,128,779 (Ho et al.).

Other aspects of the assemblies 200, 300 are generally analogous to those of assembly 100 and shall not be repeated.

Various processes may be used to apply the composite film onto the elastomeric substrate. Steps of an exemplary process can include placing the pressure sensitive adhesive layer of the composite film in contact with the elastomeric substrate, and then heating the composite film to crosslink and bond the pressure sensitive adhesive layer to the elastomeric substrate.

To facilitate a strong permanent bond, the provided composite films can be bonded to an elastomeric substrate by applying heat and pressure simultaneously. This can be accomplished by hot laminating the composite film onto the substrate. Alternatively, these steps can be performed sequentially. For example, the composite film can be pressed against the substrate at ambient temperatures, and heat later imparted to the film by conduction, convection, and/or radiation. For example, the composite film can be applied at ambient temperatures and the bonded assembly subsequently heated in an oven to crosslink the pressure-sensitive adhesive layer.

While not intended to be exhaustive, a list of exemplary embodiments relating to the provided adhesive-backed composite films are enumerated below:
1. A composite film for attachment to an elastomeric substrate, the composite film comprising the following layers, in the order below:
   an elastomeric layer comprising a thermoplastic polyurethane;
   an ink layer; and
   a pressure sensitive adhesive layer comprising a styrenic block copolymer blended with a phenolic resin.
2. The composite film of embodiment 1, wherein the phenolic resin is a phenolic resin crosslinker.
3. The composite film of embodiment 1 or 2, wherein the phenolic resin is heat-activated.
4. The composite film of any one of embodiments 1-3, wherein the phenolic resin contains active hydroxymethyl groups reactive with the styrenic block copolymer.
5. The composite film of embodiment 4, wherein the active hydroxymethyl groups are further reactive with the elastomeric substrate, whereby the composite film and the elastomeric substrate are covalently bonded to each other.
6. The composite film of any one of embodiments 1-5, wherein the phenolic resin is derived from octyl phenol.
7. The composite film of any one of embodiments 1-6, wherein the styrenic block copolymer has a molecular weight of at least 20,000 g/mol.
8. The composite film of embodiment 7, wherein the styrenic block copolymer has a molecular weight of at least 380,000 g/mol.
9. The composite film of embodiment 8, wherein the styrenic block copolymer has a molecular weight of at least 1,200,000 g/mol.
10. The composite film of any one of embodiments 1-9, wherein the pressure sensitive adhesive layer further comprises a colorant dispersed in the styrenic block copolymer blend.
11. The composite film of embodiment 10, wherein the colorant comprises a white colorant.
12. The composite film of any one of embodiments 1-11, wherein the pressure sensitive adhesive layer has a thickness of from 15 micrometers to 100 micrometers.
13. The composite film of embodiment 12, wherein the pressure sensitive adhesive layer has a thickness of from 30 micrometers to 80 micrometers.
14. The composite film of embodiment 13, wherein the pressure sensitive adhesive layer has a thickness of from 40 micrometers to 60 micrometers.
15. The composite film of any one of embodiments 1-14, wherein the elastomeric layer comprises an aliphatic polyurethane.
16. The composite film of any one of embodiments 1-15, wherein the elastomeric layer has a major surface facing the ink layer that is surface-modified.
17. The composite film of embodiment 16, wherein the surface-modified major surface of the elastomeric layer comprises a corona-treated surface.
18. The composite film of any one of embodiments 1-17, wherein the elastomeric layer has a thickness of from 25 micrometers to 500 micrometers.
19. The composite film of embodiment 18, wherein the elastomeric layer has a thickness of from 50 micrometers to 250 micrometers.
20. The composite film of embodiment 19, wherein the elastomeric layer has a thickness of from 75 micrometers to 150 micrometers.
21. The composite film of any one of embodiments 1-20, wherein the ink layer has a major surface facing the pressure sensitive adhesive layer that is surface-modified.
22. The composite film of embodiment 21, wherein the surface-modified major surface of the ink layer comprises a corona-treated surface.
23. The composite film of any one of embodiments 1-22, wherein the ink layer comprises a binder layer and a colorant dispersed therein.
24. The composite film of embodiment 23, wherein the binder layer comprises an acrylic resin, urethane resin, or combination thereof.
25. The composite film of any one of embodiments 1-24, wherein the ink layer has a thickness of from 0.5 micrometers to 25 micrometers.
26. The composite film of embodiment 25, wherein the ink layer has a thickness of from 1 micrometer to 20 micrometers.
27. The composite film of embodiment 26, wherein the ink layer has a thickness of from 3 micrometers to 12 micrometers.
28. The composite film of any one of embodiments 1-27, further comprising a tie layer disposed between the ink layer and the pressure sensitive adhesive layer.
29. The composite film of embodiment 28, wherein the tie layer comprises a polyurethane.
30. The composite film of any one of embodiments 1-29, wherein the tie layer has a thickness of from 2 micrometers to 50 micrometers.
31. The composite film of embodiment 30, wherein the tie layer has a thickness of from 5 micrometers to 25 micrometers.
32. The composite film of embodiment 31, wherein the tie layer has a thickness of from 10 micrometers to 15 micrometers.
33. A pneumatic tire comprising the composite film of any one of embodiments 1-32, wherein the elastomeric substrate is part of the pneumatic tire and permanently adhered to the composite film.
34. A process of applying the composite film of any one of embodiments 1-32 onto the elastomeric substrate, the process comprising:
   placing the pressure sensitive adhesive layer of the composite film in contact with the elastomeric substrate; and
   heating the composite film to crosslink and bond the pressure sensitive adhesive layer to the elastomeric substrate.
35. The process of embodiment 34, wherein the elastomeric substrate is part of a pneumatic tire.
36. A process of making a composite film comprising:
   disposing an ink layer on an elastomeric layer, wherein the elastomeric layer comprises a thermoplastic polyurethane; and
   disposing a pressure sensitive adhesive layer on the ink layer, the pressure sensitive adhesive layer comprising a styrenic block copolymer blended with a phenolic resin.
37. The process of embodiment 36, further comprising surface-modifying the elastomeric layer by corona treatment prior to disposing the ink layer onto the elastomeric layer.
38. The process of embodiment 36 or 37, further comprising surface-modifying the ink layer by corona treatment prior to disposing the pressure sensitive adhesive layer onto the ink layer.

### EXAMPLES

Unless otherwise noted, all parts, percentages, ratios, etc. in the Examples and the rest of the specification are by weight. Materials used in the Examples are listed in Table 1, below.

TABLE 1
Materials

| Designation | Description | Source |
|---|---|---|
| 8616 | 0.1 cm (0.04 inch) thick | 3M Company, St. Paul, |
| | thermoplastic polyurethane (TPU) | MN. United States |
| | film available under the | |
| | designation “8616” | |
| PU-1 | 0.025 cm (0.01 inch) transparent | 3M Company, St. Paul, |
| | semi-interpenetrating polymer | MN. United States |
| | network (semi-IPN) film made as | |
| | described as Example 1 Film | |
| | according to U.S. Patent No. | |
| | 9,718,242 (Marx et al) | |
| PU-2 | 0.025 cm (0.01 inch) | Huntsman International |
| | thermoplastic polyurethane (TPU) | LLC, The Woodlands, |
| | film made from PE-102 | TX. United States |
| | polyurethane resin | |
| 1903 | White screen printing ink | 3M Company, St. Paul, |
| | available under the designation | MN. United States |
| | “1903” | |
| 1905 | Black screen printing ink available | 3M Company, St. Paul, |
| | under the designation “1905” | MN. United States |
| 1913 | Red shade orange screen printing | 3M Company, St. Paul, |
| | ink available under the designation | MN. United States |
| | “1913” | |
| FL543 | White screen printing ink under | 3M Company, St. Paul, |
| | the designation of “FL 543” | MN. United States |
| FL545 | Black screen printing ink under | 3M Company, St. Paul, |
| | the designation of “FL 545” | MN. United States |
| 831 | Latex ink available under the | HP Inc., Palo Alto, CA. |
| | designation “831” | United States |
| 886 | White latex Ink available under | HP Inc., Palo Alto, CA. |
| | the designation “886” | United States |
| 872 | Latex ink available under the | HP Inc., Palo Alto, CA. |
| | designation “872” | United States |
| D1340K | Styrene-Butadiene-Styrene (SBS) | Kraton Corporation, |
| | block copolymer available under | Houston, TX. United |
| | the trade designation “KRATON | States |
| | D1340K” | |
| K100 | Aliphatic hydrocarbon resin | Zeon Chemical |
| | tackifier available under the trade | Corporation, Tokyo, |
| | designation “QUINTONE K100” | Japan |
| HRJ-4047 | Thermoplastic octyl phenolic resin | SI Group, Schenectady, |
| | available under the designation | NY. United States |
| | “HRJ-4047” | |
| HRJ-10518 | Octyl phenol reactive resin | SI Group, Schenectady, |
| | available under the designation | NY. United States |
| | “HRJ-10518” | |
| 9089 | Calcium Zinc tackifier rosin resin | Lawter, Inc, Chicago, |
| | available under the trade | IL. United States |
| | designation “PINEREZ 9089” | |
| 1520 | Liquid phenolic antioxidant | BASF SE, |
| | available under the trade | Ludwigshafen, |
| | designation “IRGANOX 1520” | Germany |
| Toluene | High pressure liquid | Sigma-Aldrich, Inc., St. |
| | chromatography (HPLC) grade | Louis, MO. |
| | solvent available under the | United States |
| | designation “Toluene” | |
| Primer 94 | Adhesion promoter available | 3M Company, St. Paul, |
| | under the trade designation “3M | MN. United States |
| | Tape Primer 94” | |
| White | White acrylic dispersion | Penn Color, |
| Acrylic | | Doylestown, PA. |
| | | United States |
| LA1114 | Acrylic block copolymer available | Kuraray Co., Tokyo, |
| | under the trade designation | Japan |
| | “Kurarity LA1114” | |
| LA2250 | Acrylic block copolymer available | Kuraray Co., Tokyo, |
| | under the trade designation | Japan |
| | “Kurarity LA2250” | |
| LA2140 | Acrylic block copolymer available | Kuraray Co., Tokyo, |
| | under the trade designation | Japan |
| | “Kurarity LA2140” | |
| Methyl | >99.5% pure solvent available | Sigma-Aldrich, Inc., St. |
| Acetate | under the designation “Methyl | Louis, MO. |
| | Acetate” | United States |
| H12MDI | Dicyclohexylmethane-4,4′- | Covestro AG, |
| | Diisocyanate available under the | Leverkusen, Germany |
| | trade designation “Desmodur W” | |
| T1400 | Polytetramethylene ether glycol | Invista, Wichita, KS. |
| | available under the trade | United States. |
| | designation “Terathane 1400” | |
| T12 | Dibutyltin dilaurate available | Evonik Industries AG |
| | under the trade designation | |
| | “Dabco T12” | |
| Acetone | Solvent available under the | Sigma-Aldrich, Inc., St. |
| | designation “Acetone” | Louis, MO. |
| | | United States |
| Isopropanol | Solvent available under the | Sigma-Aldrich, Inc., St. |
| | designation “isopropanol” | Louis, MO. |
| | | United States |
| Ethyl Acetate | Solvent available under the | Sigma-Aldrich, Inc., St. |
| | designation “ethyl acetate” | Louis, MO. |
| | | United States |
| Cyclo- | Solvent available under the | Sigma-Aldrich, Inc., St. |
| hexanone | designation “cyclohexanone” | Louis, MO. |
| | | United States |
| 3M Wheel | Cleaner available under the | 3M Company, St. Paul, |
| and Tire | designation “3M Wheel and Tire | MN. United States |
| Cleaner | Cleaner” | |

### Test Methods

### Peel Adhesion Test Method

Adhesion testing was completed following ASTM D3330/D3330M-04(2010). A new all-terrain KM2 265/70/R16 tire (obtained from BFGoodrich of Charlotte, N.C. United States) was cut on a band saw with care to yield approximately 20.32 cm×5.08 cm (8 inch×2 inch) substrates to maximize flat surface and minimize curvature. The substrates were cleaned with isopropanol and cleaning wipes until black residue ceased to rub off. Then, they dried at ambient temperature for 15 minutes before applying 1.27 cm (0.5 inch) wide tape samples by manually laying the tape onto the substrate and laminating with a 1.59 kg (3.5 lb.) roller, back and forth three times. The samples were stored at 22.2° C. (72° F.) and 50% relative humidity (RH) for 24 hours prior to testing. The samples were peeled at a peel angle of 180° and at a peel rate of 30.5 cm/minute (12 inches/minute). Peel adhesion data and respective failure modes were recorded for four replicated samples at each condition. A “1 bond” failure mode denotes adhesive failure between the adhesive and the tire substrate. A “2 bond” failure mode denoted adhesive failure between the ink and the adhesive leaving adhesive residue on the tire.

### Road Tire Test

7.62 cm×1.27 cm (3 inch×0.5 inch) sample labels were adhered onto the front driver and passenger side tires (BFGoodrich All-Terrain KM2 275/65/R16) of a 2014 Toyota Tacoma 4WD. The tires had been exposed to approximately 32K km (20K miles) of driving. Each tire was prepared by cleaning it with 3M Wheel and Tire Cleaner and then acetone with cleaning wipes until black residue ceased to rub off. On the driver side, one sample label was applied at 17.2° C. (63° F.) and 94% RH verified by a Fisherbrand Thermo-Hygro. On the passenger side, one sample label was applied after heating the tire surface to 54.4° C. (130° F.). The samples were assigned a rating of 1-5 based on the definition represented in Table 2 at pre-determined time intervals.

TABLE 2
Road Tire Test Rating Definition

| Rating | Definition |
|---|---|
| 1 | Label fully detached from tire |
| 2 | Major cracks and significant edge delamination are visible |
| 3 | Minor cracks and significant edge delamination are visible |
| 4 | No cracks and slight edge delamination or color change |
| | are visible |
| 5 | No change |

### Examples 1-30 (EX1-EX30)

### Step 1—Preparation of Pressure Sensitive Adhesives (PSA)

D1340K with various additives (refer to Table 3) and toluene were added to a glass jar and rolled on an inhouse built jar roller at approximately 60 RPM until all soluble components formed a homogeneous mixture (in about two days). For PSA-2, the Penn Color white acrylic dispersion was added once the other components were homogeneous. The adhesive compositions were coated onto 3M Command™ silicone release liner using a flatbed knife coater. To achieve a dry thickness of 30 micrometers, 45 micrometers and 60 micrometers wet gaps were set to 152.4 micrometers, 203.2 micrometers, and 304.8 micrometers respectively, creating a transfer tape. The coating laid at a speed of 2.7 m/min (9 ft/min) through a three-oven dryer with a temperature profile of 57.2° C. (135° F.) in Zone 1, 73.9° C. (165° F.) in Zone 2, and 82.2° C. (180° F.) in Zone 3. Each zone had an approximate length of 3.048 meters (10 feet).

TABLE 3
PSA Formulations

| | D1340 | K100 | HRJ10518 | HRJ4047 | 9089 | 1520 | White acrylic | Toluene |
|---|---|---|---|---|---|---|---|---|
| | (g) | (g) | (g) | (g) | (g) | (g) | (g) | (g) |
| PSA-1 | 444.94 | 253.62 | 55.62 | 0.00 | 36.93 | 8.90 | 0.00 | 800.00 |
| PSA-2 | 27.81 | 15.85 | 3.48 | 0.00 | 2.31 | 0.56 | 10.00 | 50.00 |
| PSA-3 | 100.00 | 70.00 | 0.00 | 10.00 | 0.00 | 2.00 | 0.00 | 80.00 |

### Step 2—Preparation of Acrylic Block Copolymer (ABC) Solutions

Solutions of acrylic block copolymers were prepared as represented in the Table 4. The acrylic block copolymers and ethyl acetate were weighed into a jar capable of holding 500 ml. The solutions were allowed to roll on an inhouse built jar roller at approximately 60 RPM for 18 hours until the acrylic block copolymers were completely dissolved.

TABLE 4
ABC Solution Formulations

| | LA1114 (g) | LA2140) (g) | LA2250 (g) | Ethyl Acetate (g) |
|---|---|---|---|---|
| ABC-1 | 116.5 | 50.0 | 0.0 | 250 |
| ABC-2 | 116.5 | 0.0 | 50.0 | 250 |
| ABC-3 | 166.5 | 0.0 | 0.0 | 250 |

### Step 3—Preparation of Polyurethane Solution (PU-4)

A polyurethane solution was prepared to be used as an additive in screen printed inks. The solution was prepared by weighing 71.88 g of methyl acetate into a jar capable of holding 250 ml. To the methyl acetate, 5.90 g of H12MDI and 30.00 g of T1400 were added. A magnetic stir bar was added to the jar and the mixture was stirred until the T1400 had completely dissolved (in approximately 30 minutes). 0.04 g of T12 was added to the jar and it was sealed tightly. The solution stirred for 24 hours at room temperature. This polyurethane solution sat for at least two weeks prior to use.

### Step 4—Preparation of Modified Inks

Modified screen-printed inks were prepared by weighing the designated ink base, additive, and cyclohexanone into 20 g polyethylene speed mixer cups and mixed at 3500 rpm for 2 minutes. Mixing was accomplished using a DAC 150.1 FV SpeedMixer available from FlackTek Inc, Landrum, S.C. The modified inks formulations are represented in the Table 5.

TABLE 5
Modified Ink Formulations

| | | Mass | | Mass of | Mass of |
|---|---|---|---|---|---|
| Modified | Ink | of Ink | | Additive | Cyclohexanone |
| Ink | Base | Base (g) | Additive | (g) | (g) |
| Ink-1 | 1905 | 10.00 | ABC-1 | 6.67 | 3.00 |
| Ink-2 | 1905 | 10.00 | ABC-1 | 4.30 | 3.00 |
| Ink-3 | 1905 | 10.00 | ABC-2 | 6.67 | 3.00 |
| Ink-4 | 1905 | 10.00 | ABC-2 | 4.30 | 3.00 |
| Ink-5 | 1905 | 10.00 | ABC-3 | 5.35 | 3.00 |
| Ink-6 | 1905 | 10.00 | ABC-3 | 3.33 | 3.00 |
| Ink-7 | 1905 | 10.00 | PU-4 | 10.00 | 3.00 |
| Ink-8 | 1905 | 10.00 | PU-4 | 6.67 | 3.00 |
| Ink-9 | FL545 | 10.00 | PU-4 | 10.00 | 3.00 |
| Ink-10 | FL545 | 10.00 | PU-4 | 6.67 | 3.00 |
| Ink-11 | 1903 | 10.00 | ABC-1 | 6.67 | 3.00 |
| Ink-12 | 1903 | 10.00 | ABC-1 | 4.30 | 3.00 |
| Ink-13 | 1903 | 10.00 | ABC-2 | 6.67 | 3.00 |
| Ink-14 | 1903 | 10.00 | ABC-2 | 4.30 | 3.00 |
| Ink-15 | 1903 | 10.00 | ABC-3 | 5.35 | 3.00 |
| Ink-16 | 1903 | 10.00 | ABC-3 | 3.33 | 3.00 |
| Ink-17 | 1903 | 10.00 | PU-4 | 10.00 | 3.00 |
| Ink-18 | 1903 | 10.00 | PU-4 | 6.67 | 3.00 |
| Ink-19 | FL543 | 10.00 | PU-4 | 10.00 | 3.00 |
| Ink-20 | FL543 | 10.00 | PU-4 | 6.67 | 3.00 |

### Step 5—Preparation of Labels

Sample labels were assembled as represented in the Table 6.

TABLE 6
Sample Label Formulations

| | | | | | Adhesive |
|---|---|---|---|---|---|
| | Polyurethane | Colored | White | | Thickness |
| | Film | Ink | Ink | Adhesive | (micrometers) |
| EX1 | 8616 | 1913 | 1903 | PSA-1 | 30 |
| EX2 | PU-1 | 1905 | None | PSA-1 | 30 |
| EX3 | PU-2 | 831 Black | None | PSA-1 | 30 |
| EX4 | PU-2 | 831 Black | None | PSA-2 | 30 |
| EX5 | PU-2 | 831 Black | None | PSA-1 | 60 |
| EX6 | PU-2 | 872 | 886 | PSA-1 | 30 |
| EX7 | PU-2 | 1905 | 1903 | PSA-1 | 45 |
| EX8 | PU-2 | Ink-1 | Ink-11 | PSA-1 | 45 |
| EX9 | PU-2 | Ink-2 | Ink-12 | PSA-1 | 45 |
| EX10 | PU-2 | Ink-3 | Ink-13 | PSA-1 | 45 |
| EX11 | PU-2 | Ink-4 | Ink-14 | PSA-1 | 45 |
| EX12 | PU-2 | Ink-5 | Ink-15 | PSA-1 | 45 |
| EX13 | PU-2 | Ink-6 | Ink-16 | PSA-1 | 45 |
| EX14 | PU-2 | Ink-7 | Ink-17 | PSA-1 | 45 |
| EX15 | PU-2 | Ink-8 | Ink-18 | PSA-1 | 45 |
| EX16 | PU-2 | Ink-9 | Ink-19 | PSA-1 | 45 |
| EX17 | PU-2 | Ink-10 | Ink-20 | PSA-1 | 45 |
| EX18 | PU-2 | 1905 | 1903 | PSA-3 | 45 |
| EX19 | PU-2 | Ink-1 | Ink-11 | PSA-3 | 45 |
| EX20 | PU-2 | Ink-2 | Ink-12 | PSA-3 | 45 |
| EX21 | PU-2 | Ink-3 | Ink-13 | PSA-3 | 45 |
| EX22 | PU-2 | Ink-4 | Ink-14 | PSA-3 | 45 |
| EX23 | PU-2 | Ink-5 | Ink-15 | PSA-3 | 45 |
| EX24 | PU-2 | Ink-6 | Ink-16 | PSA-3 | 45 |
| EX25 | PU-2 | Ink-7 | Ink-17 | PSA-3 | 45 |
| EX26 | PU-2 | Ink-8 | Ink-18 | PSA-3 | 45 |
| EX27 | PU-2 | Ink-9 | Ink-19 | PSA-3 | 45 |
| EX28 | PU-2 | Ink-10 | Ink-20 | PSA-3 | 45 |
| EX29 | PU-2 | Ink-3 | Ink-13 | PSA-1 | 60 |
| EX30 | PU-2 | 1905 half | 1903 half | PSA-1 | 45 |
| | | tone | tone | | |

The labels were prepared by first corona treating a 30.5 cm×30.5 cm (12-inch×12 inch) sample of polyurethane film at a 0.4 J/cm² dosage using a UBT 400MM TW corona treater, obtained from Pillar Technologies, Hartland, Wis. United States.

The treated surface for Example 1 was screen printed using a layer of 1913 ink followed by a layer of white 1903 ink. Both ink layers were printed with a 230-48 mesh screen and samples were air dried for 24 hours between layers. The ink was screen printed using a A-AT-60PD ATMA Digital Electric Flat Screen Printer obtained from ATMA Champ Ent. Corp, Taoyuan City, Taiwan.

The ink was primed with a thin coating of Primer 94 with a cotton swab and allowed to dry in ambient conditions for at least two hours. The transfer tape, PSA-1 with a 30-micrometer thickness, was laminated to the screen-printed polyurethane using a Dual Heat Roll Laminator, obtained from ChemInstruments, Fairfield, Ohio United States, operated at room temperature, a pressure of 0.275 MPa (40 psi), and a nominal speed of 3.0 m/min (10 ft/min).

Example 2 was screen printed using the same method as Example 1 except no white layer was used. The PSA was laminated to the ink surface using the lamination method previously described. Examples 3, 4, and 5 were printed on a HP 360 Printer, available from HP Inc., Palo Alto, Calif. United States. The PSA was laminated using the lamination method previously described.

Example 6 was printed using a HP Latex R1000 Plus Printer, available from HP Inc., Palo Alto, Calif. United States. The PSA was laminated using the lamination method previously described.

Examples 7-29 were prepared by coating the ink using a notch bar coater set to a gap of approximately 50 micrometers. The colored ink was coated first and allowed to dry at room temperature for at least two hours. The white ink was then subsequently coated on top of the colored layer and allowed to dry for 24 hours at room temperature. The PSA was then laminated to the ink surface using the lamination method previously described.

Example 30 was prepared by screen printing the 1905 ink at 55% halftone, with an approximate ink density of 60 dots per inch. Three layers of halftone ink were applied on top of each other with the same conditions as Example 1. Three layers of halftone 1903 ink at 55% halftone with an approximate ink density of 23.6 dots per cm (60 dots per inch) were then applied on top of the 1905 halftone with the same conditions as Example 1. The PSA was then laminated to the ink surface using the lamination method previously described.

### Step 6—Sample Testing

Four samples of Example 1 underwent Peel Adhesion testing and the results are represented in Table 7.

TABLE 7
Example 1 Peel Adhesion Test Results

| Sample | Peel Adhesion | Failure |
|---|---|---|
| N/mm | (lb./inch) | Mode |
| 1 | 1.12 (6.40) | 1 Bond |
| 2 | 1.19 (6.80) | 1 Bond |
| 3 | 0.96 (5.5) | 1 and 2 Bond |
| 4 | 1.91 (10.9) | 1 and 2 Bond |

Examples 2-6 were applied to the front driver's side and passenger side tires per the Road Tire Test method. The labels were inspected after 110 days (8611 km or 5351 miles) of typical driving conditions. The results are shown in the Table 8.

TABLE 8
Examples 2-6 Road Tire Test Results

| | Tire Location | Rating |
|---|---|---|
| EX2 | Driver side, Front | 1 |
| EX3 | Driver side, Front | 5 |
| EX4 | Driver side, Front | 5 |
| EX5 | Driver side, Front | 5 |
| EX6 | Driver side, Front | 4 |
| EX2 | Passenger side, Front | 1 |
| EX3 | Passenger side, Front | 5 |
| EX4 | Passenger side, Front | 5 |
| EX5 | Passenger side, Front | 5 |
| EX6 | Passenger side, Front | 4 |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given to enable one of ordinary skill in the art to practice the claimed disclosure, is not to be construed as limiting the scope of the disclosure, which is defined by the claims and all equivalents thereto.

1. A composite film for attachment to an elastomeric substrate, the composite film comprising the following layers, in the order below:
an elastomeric layer comprising a thermoplastic polyurethane;
an ink layer; and
a pressure sensitive adhesive layer comprising a styrenic block copolymer blended with a phenolic resin.

2. The composite film of claim 1, wherein the phenolic resin is a phenolic resin crosslinker.

3. The composite film of claim 1, wherein the phenolic resin is heat-activated.

4. The composite film of claim 1, wherein the phenolic resin is derived from octyl phenol.

5. The composite film of claim 1 wherein the pressure sensitive adhesive layer further comprises a colorant dispersed in the styrenic block copolymer blend.

6. The composite film of claim 1, wherein the elastomeric layer comprises an aliphatic polyurethane.

7. The composite film of claim 1, wherein the elastomeric layer has a major surface facing the ink layer that is surface-modified.

8. The composite film of claim 7, wherein the surface-modified major surface of the elastomeric layer comprises a corona-treated surface.

9. The composite film of claim 1, wherein the ink layer has a major surface facing the pressure sensitive adhesive layer that is surface-modified.

10. The composite film of claim 9, wherein the surface-modified major surface of the ink layer comprises a corona-treated surface.

11. The composite film of claim 1, wherein the ink layer comprises a binder layer and a colorant dispersed therein, the binder layer comprising an acrylic resin, urethane resin, or combination thereof.

12. The composite film of claim 1, further comprising a tie layer disposed between the ink layer and the pressure sensitive adhesive layer, the tie layer comprising a polyurethane.

13. A pneumatic tire comprising the composite film of claim 1, wherein the elastomeric substrate is part of the pneumatic tire and permanently adhered to the composite film.

14. A process of applying the composite film of claim 1 onto the elastomeric substrate, the process comprising:
placing the pressure sensitive adhesive layer of the composite film in contact with the elastomeric substrate; and
heating the composite film to crosslink and bond the pressure sensitive adhesive layer to the elastomeric substrate.

15. A process of making a composite film comprising:
disposing an ink layer on an elastomeric layer, wherein the elastomeric layer comprises a thermoplastic polyurethane; and
disposing a pressure sensitive adhesive layer on the ink layer, the pressure sensitive adhesive layer comprising a styrenic block copolymer blended with a phenolic resin.
